(19) United States
(12) Patent Application Publication
(10) Pub. No.: US 2016/0340040 A1
(43) Pub. Date: Nov. 24, 2016

(54) LOCKING OF FLAPS

(71) Applicant: Kendrion Kuhnke Automation GmbH, Malente (DE)

(72) Inventors: Borgar Pfeiffer, Schwentinental (DE); Bleik Teunis, Kiel (DE)

(73) Assignee: Kendrion Kuhnke Automation GmbH, Malente (DE)

(21) Appl. No.: 14/815,053

(22) Filed: Jul. 31, 2015

(30) Foreign Application Priority Data
May 20, 2015 (DE) 102015209249.6

(51) Int. Cl. B64D 11/00; E05C 19/16

(52) U.S. Cl. CPC B64D 11/00; E05C 19/16; B64D 2231/025

(57) ABSTRACT

A device for locking a holding pin connected with a cover with a holding pin for the cover, with a magnet. The device has a rotational body held in an end position by the magnet. The rotational body has inside a receiving area provided with an inner wall for at least one ball and for the holding pin, wherein in the receiving area of the rotational body the at least one ball is arranged between the inner wall of the receiving area of the rotational body and the holding pin arranged inside the receiving area under formation of a form fit for locking the holding pin and for unlocking the holding pin by turning the rotational body, the clamp effect of the at least one ball is reduced or removed through the spacing of the at least one ball from the holding pin so that the holding pin is movable.

### CROSS REFERENCE TO RELATED APPLICATIONS

The present application claims priority benefit under German Patent Application No. 10 2015 209 249.6 filed on May 20, 2015, the entirety of which is incorporated by reference herein.

### FIELD

The invention relates to a device for locking a holding pin connected with a cover, in particular a flap, as well as a use of such a device. Moreover, the invention relates to an oxygen supply unit, in particular an emergency oxygen supply unit, of an airplane.

### BACKGROUND

It is known that oxygen supplies or respectively oxygen supply units are present in airplanes or respectively aircraft for passengers, in case the central pressurization of an airplane cabin fails. The oxygen systems used are hereby arranged above the passenger seats in the airplane cabin so that, in the event of a drop in pressure, the flaps of the oxygen supply units are opened or respectively unlocked in an emergency, in order to supply the passengers with oxygen.

Known oxygen supply devices for airplanes generally have a receptacle in which at least one oxygen mask is arranged. Furthermore, the receptacle has a cover, which unlocks when triggered, whereby the oxygen mask is released.

For example, DE 10 2004 026 649 A1 and EP 2 229 319 B1 describe devices for supplying oxygen to passengers in an airplane.

### SUMMARY

Based on the aforementioned state of the art, an object of the invention is to provide a small-sized locking unit for the flaps or respectively covers in particular of an oxygen supply device in airplanes.

This object is solved by a device for locking a holding pin connected with a cover, in particular a flap, with a holding pin for the cover, with a, preferably energizable, magnet, in particular a holding solenoid, and with a rotational body held in an end position, in particular locking position, by the magnet, wherein the rotational body has inside a receiving area provided with an inner wall for at least one ball, in particular for three balls, and for the holding pin, wherein in the receiving area of the rotational body in the end position of the rotational body the at least one ball, in particular three balls, is arranged between the inner wall of the receiving area of the rotational body and the holding pin arranged inside the receiving area under formation of a form fit for locking the holding pin and for unlocking the holding pin by turning the rotational body, the clamp effect of the at least one ball is or will be reduced or is removed through the spacing of the at least one ball from the holding pin so that the holding pin is movable, in particular freely or linearly.

The invention is based on the idea that a rotatory ball locking system is provided for the holding pin of a cover of an oxygen supply device of an airplane using a rotational member, wherein the installation height of the locking unit in relation to known conventional devices is reduced through the use of the rotational member and of a lying magnet or respectively holding solenoid.

Several, in particular three, balls are preferably arranged in the receiving area of the rotational member for forming the ball locking system, which are arranged between the inner wall of the receiving area of the rotational body and the holding pin. In the locking position, the balls clamping the holding pin are each in contact with the inner wall of the receiving area and with the holding pin. The holding pin itself is connected with the flap to be locked or the cover to be locked, wherein the holding pin is inserted into the receiving area in order to lock the flap. Through the latching of the clamp of the holding pin by means of the balls provided in the receiving area of the rotational body, the holding pin is blocked or respectively latched in the axial direction.

In order to release the latching of the holding pin, the rotational body is turned, whereby the clamp effect of the balls brought in contact with the holding pin is lowered or removed, whereby the holding pin is released and the holding pin is movable or is moved in the axial direction. Through the rotation of the rotational body, the form fit between the at least one ball or respectively the balls and the holding pin is released, wherein the balls are hereby released and move away from the holding pin.

For this, it is preferred in a further development of the device that the rotational body has a lever arm for the magnet arranged on the outside, wherein in particular the lever arm has a holding body for the magnet. In the locking position of the device, the holding plate arranged on the lever arm is hereby moved to rest against the magnet or respectively holding solenoid, whereby the holding plate formed as a holding body is kept currentless by the permanent magnetic field of the magnet. Through the rotational body held in the locking position, the balls provided in the receiving area of the rotational body are moved to rest against the holding pin so that the holding pin is blocked or respectively latched in the axial direction.

A spring device, in particular a spring, engaging with the rotational body is preferably provided so that the rotational body is or will be moved to rotate upon unlocking of the holding pin by means of the spring device.

Through a spring device or respectively spring arranged on the rotational body, the rotational body is moved to rotate upon unlocking of the holding pin as soon as the holding force of the holding solenoid upon supplying the coil of the holding solenoid with current, during which the coil flow acts against the permanent magnetic flow, is cancelled and is less than the spring force of the spring device. The inner wall of the rotational body is hereby twisted relative to the balls during the rotational movement of the rotational body until the latching or respectively the clamp effect of the balls is cancelled. The balls are hereby removed from the holding pin in the radial direction so that the clamping or respectively latching of the holding pin is cancelled and the holding pin is freely movable in the axial direction.

Moreover, one embodiment of the device is characterized in that an actuatable or respectively manually actuatable unlocking device, in particular an unlocking pin, is provided, wherein the unlocking device acts together with an unlocking gate provided on the rotational body, wherein the rotational body is rotatable into the unlocking position through actuation of the unlocking device.

Moreover, it is preferred in one embodiment of the device that an actuatable, preferably manually actuatable, locking device, in particular a locking pin, is provided, wherein the locking device acts together with a locking gate arranged on the rotational body, wherein the rotational body is rotatable into the locking position through actuation of the locking device.

It is thereby advantageous that the unlocking gate and/or the locking gate are formed on an arm member arranged on the rotational body. Within the framework of the invention, it is possible that the unlocking gate and the locking gate are respectively provided on a separate arm member so that the rotational body is brought into the respective unlocking position or locking position. Within the framework of the invention, it is also possible that the unlocking gate and the locking gate are formed on a common arm member.

Furthermore, it is advantageous in one embodiment that the inner wall of the receiving area of the rotational body has a narrowing area for the at least one ball or for the balls, wherein in the locking position of the rotational body the narrowing area of the receiving area is brought or can be brought in contact with the at least one ball or with the balls. Through the narrowing area of the inner wall, the diameter of the receiving area varies so that the distance between the balls and the holding pin is changeable through the rotation of the rotational body. Through the narrowing area of the rotational body, the inner wall is formed such that in one embodiment with latched balls little torque acts on the rotational body in the opening direction, whereby the opening process and the rotation of the rotational body out of the locking position into the unlocking position is facilitated.

Moreover, a preferred design of the device is characterized in that the inner wall of the receiving area of the rotational body has a recess for the at least one ball, wherein the at least one ball is arrangeable or arranged in the recess in the unlocking position of the rotational body. In particular, several recesses for one ball each are provided on the rotational body, wherein respectively one ball is arranged in the recess provided for this in the unlocking position.

Moreover, it is advantageous in a further development of the device that the holding pin has a narrowing area and a head area with a larger diameter than the narrowing area, wherein in particular upon locking of the holding pin the at least one ball rests in a clamping manner on the narrowing area of the holding pin. The holding pin is thereby formed as a cylindrical pin with a ball head or the like, wherein the diameter of the ball or respectively the balls is greater than the diameter of the holding pin. In particular, the diameter of the ball or respectively the balls is greater than the maximum diameter of the holding pin or greater than the diameter of the narrowing area of the holding pin.

Moreover, the inner wall of the receiving area of the rotational body is preferably formed as a latching surface at least in sections in the circumferential direction, wherein at least one ball or the balls fit, in particular in a form-fitting manner, between the latching surface and the holding pin in the locking position of the rotational body and the balls latching the holding pin are not in contact with the latching surface in the unlocking position of the rotational body.

It is thereby preferred that the latching surface in relation to the rotational axis of the rotational body is formed such that the distance between the latching surface and the rotational axis of the rotational body is or respectively will be smaller at least in sections in the circumferential direction.

In a further embodiment of the device, it is preferred that the at least one ball is supplied with a torque in interaction with the rotational body in the locking position of the rotational body.

A, preferably fixed, ball cage is thus advantageously provided in the receiving area of the rotational body for the at least one ball, wherein in particular the ball cage has several recesses for receiving one ball each in the circumferential direction.

The object is further solved through the use of a device for locking a holding pin connected with a cover, in particular a flap, with a holding pin for the cover on an oxygen supply unit, in particular emergency oxygen supply unit, of an airplane.

The oxygen supply units hereby have a cover, which are lockable or respectively unlockable by means of the device described above and the holding pin arranged on the cover of the oxygen supply units.

Furthermore, the object is solved by an oxygen supply unit, in particular emergency oxygen supply unit, of an airplane with a cover and with a device described above for locking a holding pin provided with the cover, in particular a flap.

In order to avoid repetitions reference is made expressly to the above explanations.

Further characteristics of the invention will become apparent from the description of embodiments according to the invention together with the claims and the included drawings. Embodiments according to the invention can fulfil individual characteristics or a combination of several characteristics.

### BRIEF DESCRIPTION OF THE FIGURES

The invention is described below, without restricting the general idea of the invention, using exemplary embodiments with reference to the drawings, whereby we expressly refer to the drawings with regard to all details according to the invention that are not explained in greater detail in the text. The figures show in:

FIGS. 1a), 1b) schematically respectively a view of a locking device of a cover of an oxygen supply unit in the locking position (FIG. 1a) and in the unlocking position (FIG. 1b),

FIG. 2 schematically a perspective view of a rotational body for the locking unit in detail and

FIG. 3 schematically a cross-section through a rotational body of the locking unit in detail.

In the drawings, the same or similar elements and/or parts are provided with the same reference numbers in order to prevent the item from needing to be reintroduced.

### DETAILED DESCRIPTION

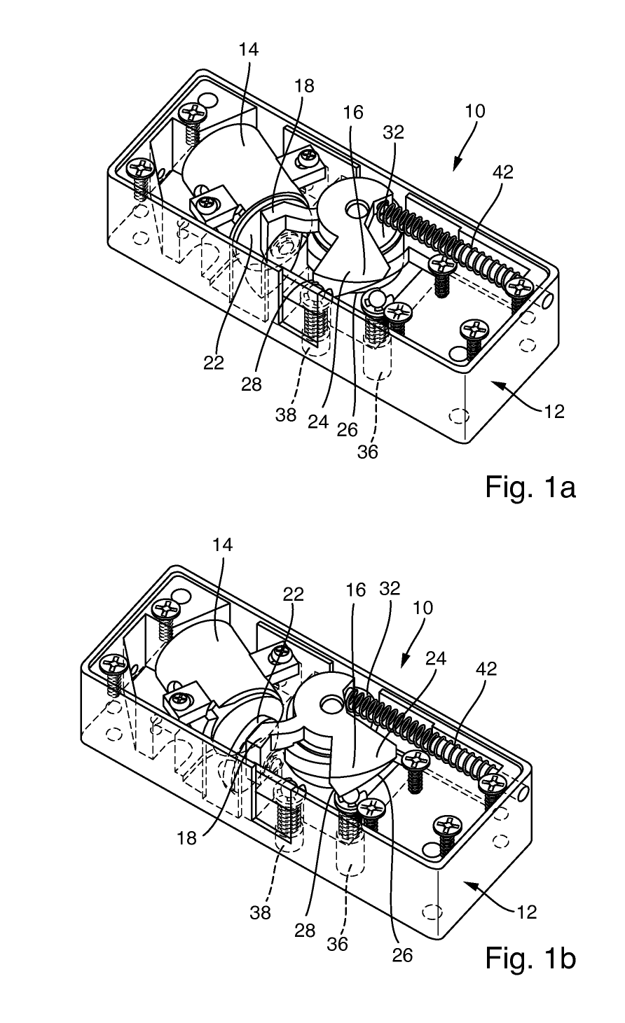

FIGS. 1a), 1b) show respectively perspective representations of a locking unit 10 for a holding pin 52 of a cover of an oxygen supply unit S for airplanes in detail. The locking unit 10 is shown in FIG. 1a) in the locking position, while the representation according to FIG. 1b) shows the locking unit 10 in the open state (unlocking position).

The locking unit 10 has a housing 12, in which the components of the locking unit 10 are arranged. For better presentability, the representations in FIGS. 1a) and 1b) show the housing 12 without the top cover.

A holding solenoid 14, which can be supplied with current and which is arranged in a lying manner, is arranged inside the housing 12. Moreover, a rotational body 16 is arranged inside the housing 12 next to the holding solenoid 14, wherein the rotational body 16 has a lever arm 18 on its outside, on which a holding plate 22 is arranged.

The rotational body 16 is rotatably mounted so that the holding plate 22 in the locking position (see FIG. 1a) rests on the holding solenoid 14 or respectively on the front side of the holding solenoid 14, wherein the holding plate 22 is held currentless in the locking position by the permanently magnetic field of the holding solenoid 14.

Furthermore, the rotational body 16 has another wing arm 24, on the bottom side of which a locking gate 26 and an unlocking gate 28 are formed. The locking gate 26 and the unlocking gate 28 are formed on the bottom side of the wing arm 24 and interact respectively with a spring-mounted locking pin 36 or respectively with a spring-mounted unlocking pin 38.

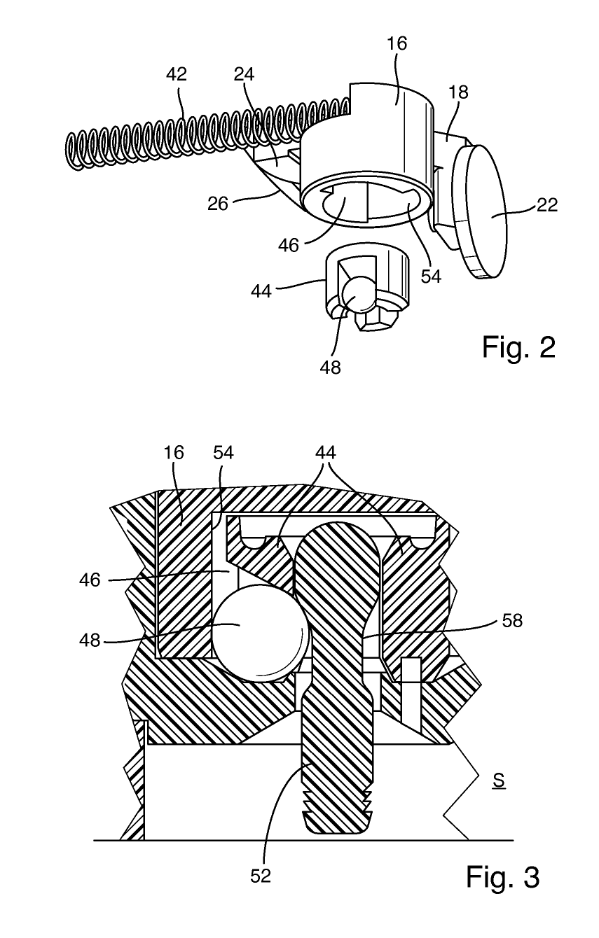

FIG. 2 shows in a perspective view the rotational body 16 from a different viewing direction while omitting additional details of the locking unit 10.

Referring back to FIGS. 1a), 1b) a manually actuatable locking pin 36 and a manually actuatable emergency unlocking pin 38, which interact by pressing with the locking gate 26 or respectively the unlocking gate 28, are arranged on the bottom side of the housing 12.

A recess 32 is provided on the top side of the rotational body 16 so that a spring 42 arranged in the housing 12 is arranged in the recess 32. The other end of the spring 42 is supported on the inside of the housing 12 so that the pretensioned spring 42 in the locking position (FIG. 1a) exerts a force on the locked or respectively held rotational body 16, whereby the unlocking process is supported.

As can be seen from FIG. 2, the rotational body 16 has inside a receiving area 46, in which a ball cage 44 is arranged. The preferably fixed ball cage 44 has several arms so that, between the arms, respectively one recess is provided for each ball 48. The ball cage 44 preferably has three recesses for respectively one ball 48.

FIG. 3 shows schematically a cross-section through the rotational body 16 in detail. For locking a schematically indicated oxygen supply unit S, a holding pin 52 is arranged in the receiving area 46 of the locking unit 10.

The holding pin 52 to be locked is formed as a cylindrical pin with a ball head or the like, wherein the diameter of the ball 48 is greater than the diameter of the holding pin 52 formed as the pin cylinder. The holding pin 52 is hereby fastened on the flap to be locked or respectively the cover of the oxygen supply unit S to be locked. For locking, the holding pin 52 is inserted into the receiving area 46 of the rotational body 16 and is blocked or respectively latched by triggering a locking process in the axial direction. Furthermore, the holding pin 52 has a narrowing area 58, so that during the locking of the holding pin 52 the balls 48 are moved to rest against the narrowing area 58.

In the locking position (see FIG. 1a), the rotational body 16 presses the three balls 48 arranged in the receiving area 46 radially into the ball case 44 using a latching surface 54 on the inside so that the balls 48 rest below the ball head of the holding pin 52 in the narrowing area 58, whereby the holding pin 52 is latched in the axial direction. In the axial direction, the balls 48 rest on a horizontal surface.

The latching surface 54 of the rotational body 16 is formed such that, in the case of latched balls 48, a torque acts in the opening direction on the rotational body 16, whereby the unlocking process is additionally supported.

The latching surface 54 of the rotational body 16 can preferably be formed as a free-form surface so that it forms an ever decreasing radius over an angle area.

In another embodiment, the latching surface 54 is specified in sections over the perimeter. The balls 48 provided for the latching thereby generate an axial force, whereby a torque can additionally be executed using a radially chamfered surface. Furthermore, recesses neighboring the latching surface 54 can be attached to the non-conical sections adjacent to the perimeter, whereby a radial shifting of the balls 48 is enabled during the unlocking of the holding pin 52.

When the coil of the holding solenoid 14 is supplied with current, the coil flux acts against the permanent magnetic flux, whereby the holding force of the holding solenoid 14 is removed. Through the spring 42 fastened on the rotational body 16, the rotational body 16 is moved to rotate as soon as the holding force of the holding solenoid 14 is less than the spring force. During the rotational movement, the latching surface 54 of the rotational body 16 is rotated relative to the balls 48, until the clamp effect of the balls 48 is cancelled. During the unlocking, the balls 48 are removed for example radially on a horizontal plane of the housing 12 from the holding pin 52 until the latching of the holding pin 52 is cancelled and the holding pin 52 is free for an axial movement.

For the locking, the holding pin 52 connected with the flap is inserted into the rotational body 16 through an opening in the housing 12 with the ball head during the manual closing of the flap until a locking is enabled using the rotational body 16 and the balls 48 arranged in the rotational body 16. For the locking, the locking pin 36 can be actuated so that in interaction of the locking pin 36 with the locking gate 26 the balls 48 are clamped between the latching surface 54 and the holding pin 52.

For an emergency unlocking of the locking unit 10, it is possible that the emergency unlocking pin 38 is actuated manually so that in interaction with the unlocking gate 28 the rotational body 16 is moved to rotate, whereby the balls 48 resting on the holding pin 52 are distanced from the holding pin 52 during the rotation of the rotational body 16.

All named characteristics, including those taken from the drawings alone and also individual characteristics which are disclosed in combination with other characteristics are considered alone and in combination as essential for the invention. Embodiments according to the invention can be realized by individual characteristics, or a combination of several characteristics. In the scope of the invention, characteristics, which are designated with “in particular” or “preferably” are understood to be facultative features.

### LIST OF REFERENCE NUMBERS

10 Locking unit
12 Housing
14 Holding solenoid
16 Rotational body
18 Lever arm
22 Holding plate
24 Wing arm
26 Locking gate
28 Unlocking gate
32 Recess
36 Locking pin
38 Unlocking pin
42 Spring
44 Ball cage
46 Receiving area
48 Ball
52 Holding pin
54 Latching surface
58 Narrowing area
S Oxygen supply unit

What is claimed is:

1. A device (10) for locking a holding pin (52) connected with a cover with a magnet (14), and with a rotational body (16) held in an end position by the magnet (14), wherein the rotational body (16) has inside a receiving area (46) provided with an inner wall (54) for at least one ball (48), and for the holding pin (52), wherein in the receiving area (46) of the rotational body (16) in the end position of the rotational body (16) the at least one ball (48), is arranged between the inner wall (54) of the receiving area (46) of the rotational body (16) and the holding pin (52) arranged inside the receiving area (46) under formation of a form fit for locking the holding pin (52) and for unlocking the holding pin (52) by turning the rotational body (16), the clamp effect of the at least one ball (48) reduced or removed through spacing of the at least one ball (48) from the holding pin (52) so that the holding pin (52) is movable.

2. The device (10) according to claim 1, wherein the rotational body (16) has a lever arm (18) for the magnet (14) arranged on the outside.

3. The device (10) according to claim 1, further comprising a spring device (42), engaging with the rotational body (16) so that the rotational body (16) is moved to rotate upon unlocking of the holding pin (52) by means of the spring device (42).

4. The device (10) according to claim 1, further comprising an actuatable unlocking device (38) wherein the unlocking device (38) acts together with an unlocking gate (28) provided on the rotational body (16), wherein the rotational body (16) is rotatable into the unlocking position through actuation of the unlocking device (38).

5. The device (10) according to claim 1, further comprising an actuatable locking device (36), wherein the locking device (36) acts together with a locking gate (26) arranged on the rotational body (16), wherein the rotational body (16) is rotatable into the locking position through actuation of the locking device (36).

6. The device (10) according to claim 4, wherein the unlocking gate (28) and/or the locking gate (26) are formed on an arm member (24) arranged on the rotational body (16).

7. The device (10) according to claim 1, wherein the inner wall (54) of the receiving area (46) of the rotational body (16) has a narrowing area for the at least one ball (48), wherein the narrowing area of the receiving area (46) is in contact with the at least one ball (48) in the locking position of the rotational body (16).

8. The device (10) according to claim 1, wherein the inner wall (54) of the receiving area (46) of the rotational body (16) has a recess for the at least one ball (48), wherein the at least one ball (48) is arranged in the recess in the unlocking position of the rotational body (16).

9. The device (10) according to claim 1, wherein the holding pin (52) has a narrowing area (58) and a head area with a larger diameter than the narrowing area (58), wherein upon locking of the holding pin (52) the at least one ball (48) rests in a clamping manner on the narrowing area (58) of the holding pin (52).

10. The device (10) according to claim 1, wherein the inner wall (54) of the receiving area (46) of the rotational body (16) is formed at least in sections in the circumferential direction as a latching surface (54).

11. The device (10) according to claim 10, wherein the latching surface (54) in relation to the rotational axis of the rotational body (16) is formed such that the distance between the latching surface (54) and the rotational axis of the rotational body (16) is smaller at least in sections in the circumferential direction.

12. The device (10) according to claim 1, wherein the at least one ball (48) is supplied with a torque in interaction with the rotational body (16) in the locking position of the rotational body (16).

13. The device (10) according to claim 1, further comprising a ball cage (44) is provided in the receiving area (46) of the rotational body (16) for the at least one ball (48), wherein the ball cage (44) has several recesses for receiving one ball (48) each in the circumferential direction.

14. A method for locking a cover of an oxygen supply unit, the method comprising connecting a locking device to the cover of the oxygen supply unit with a holding pin.

15. An oxygen supply unit (S), of an airplane with a cover and with a device (10) for locking a holding pin (52) connected with the cover, in particular a flap, according to claim 1.
